(19) United States
(12) Patent Application Publication
(10) Pub. No.: US 2007/0101964 A1
(43) Pub. Date: May 10, 2007

(54) Valve seat for engine method of manufacturing the valve seat, and cylinder head for engine

(75) Inventors: Koichiro Morimoto, Niigata (JP); Kunio Hanada, Niigata (JP); Takashi Nishida, Niigata (JP); Tomohiro Sakai, Niigata (JP)

Correspondence Address: DARBY & DARBY P.C., P. O. BOX 5257, NEW YORK, NY, 10150-5257, US

(73) Assignee: MITSUBISHI MATERIALS PMG CORPORATION, NIIGATA JAPAN (JP)

(21) Appl. No.: 10/572,887

(22) PCT Filed: Sep. 30, 2004
(86) PCT No.: PCT/JP04/14334

§ 371 Date: Mar. 20, 2006

(30) Foreign Application Priority Data
Sep. 30, 2003 (JP) 2003-341541
Sep. 30, 2003 (JP) 2003-341542
Sep. 30, 2003 (JP) 2003-341543

(51) Int. Cl. F02N 3/00

(52) U.S. Cl. 123/188.8

(57) ABSTRACT

An engine fuel essentially consisting of alcohol may contain a relatively large amount of water in comparison with conventional gasoline and diesel oil, so that when water possibly penetrates into a clearance between an intake valve seat and a mounting reception portion of a cylinder head where the valve seat is to be mounted when the engine fuel essentially consisting of alcohol together with air is introduced into a cylinder through an air inlet having the intake valve seat. As a plating layer 14 is formed on the surface of an iron-based valve seat main body 17 provided at a mounting reception portion 13 formed at an air inlet 6 of a cylinder head 2 made of an aluminum alloy, the plating layer 14 intervenes between the cylinder head 2 and the valve seat main body 17, so that a potential difference between the dissimilar metals for the mounting reception portion 13 and the valve seat main body 17 is reduced through water, thereby preventing galvanic corrosion.

### CROSS-REFERENCE TO PRIOR APPLICATION

This is a U.S. National Phase Application under 35 U.S.C. §371 of International Patent Application No. PCT/JP2004/014334 filed Sep. 30, 2004, and claims the benefit of Japanese Patent Application Nos. 2003-341541 filed Sep. 30, 2003; 2003-341542 filed Sep. 30, 2003 and 2003-341543 filed Sep. 30, 2003, all of which are incorporated by reference herein. The International Application was published in Japanese on Apr. 7, 2005 as WO 2005/031126 a1 under PCT Article 21(2).

### TECHNICAL FIELD

The present invention relates to an engine valve seat, a manufacturing method thereof, and an engine cylinder head.

### BACKGROUND ART

As disclosed in Japanese Unexamined Patent Publication No. H7-133705, Japanese Unexamined Patent Publication No. S58-77114, and Japanese Unexamined Patent Publication No. S58-77116, such a conventional type is known which can improve wear resistance and further reduce a mutual damage by forming an iron oxide film essentially consisting of Fe₃O₄ on the surface of a valve seat made of an iron-based sintered alloy, so that it can be applied to, particularly, an intake valve seat of a high power internal combustion engine, such as a diesel engine or an LPG engine, which does not likely generate combustion products. Also known is a valve seat obtained by performing an infiltration process on a primary sintered alloy, processing it to an almost finished size, and performing oxidation, and is therefore applicable to an LPG engine or a hydrogen engine which improves thermal conductivity by an infiltrated plating layer and wear resistance by an oxide film on a valve abutment surface. Further known is a valve seat applicable to an LPG engine, a hydrogen engine, a high-lead gasoline engine, or an exhaust gas recirculation apparatus (E.G.R).The valve seat is made of a sintered alloy press-molded, sintered and processed to a predetermined size is mounted in a cylinder head and is then subjected to a steam treatment to form an oxide film.

Recently, an engine fuel that essentially consists of alcohol which generates a relatively clean exhaust gas became popular. Such a fuel, together with air, is introduced into a combustion chamber through an air inlet, and the fuel is burned after an intake valve seat provided at the air inlet is closed by an intake valve, thereby acquiring power. Subsequently, an exhaust valve seat provided at an air outlet is opened by an exhaust valve, thereby exhausting an exhaust gas.

### DISCLOSURE OF THE INVENTION

### Problems to be Solved by the Invention

The engine fuel essentially consisting of alcohol may contain a relatively large amount of water in comparison with conventional gasoline and diesel oil. The water can possibly penetrate into a clearance between the intake valve seat and the mounting reception portion of a cylinder head in which the valve seat is mounted when the engine fuel essentially consisting of alcohol is introduced together with air into the cylinder through the air inlet having the intake valve seat. If there is water in the clearance between the intake valve seat and the mounting reception portion in this manner, galvanic corrosion may occur in a case of dissimilar metal contact. For example, the intake valve seat can be an iron-based metal and, the mounting reception portion and therefore the cylinder head are aluminum-based metals. That is, according to the galvanic corrosion, when dissimilar metals contact with each other with water being present therebetween, electricity is generated, so that a naturally charged metal is corroded. In a case of aluminum and iron, aluminum is negatively charged and is corroded. As a result, for example, a hole which leads from the mounting reception portion to a cooling channel may be formed in the cylinder head.

The conventional technologies form an iron oxide film on the valve seat to improve wear resistance but, it cannot prevent galvanic corrosion occurred in an engine which uses the engine fuel essentially consisting of alcohol.

Such galvanic corrosion may also occur at the mounting reception portion of the air outlet side and the exhaust valve seat.

An object of the invention is to provide an engine valve seat, a manufacturing method thereof, and an engine cylinder head which can prevent galvanic corrosion even if an intake or exhaust valve seat and a mounting reception portion are a combination of dissimilar metals.

### MEANS FOR SOLVING THE PROBLEMS

A first aspect of the present invention proposes an engine valve seat with a plating layer formed on a surface of a valve seat main body provided at a mounting reception portion provided at an air inlet or air outlet of a cylinder head.

A second aspect of the present invention proposes an engine valve seat with a plating layer formed on at least that surface of a valve seat main body, provided at a mounting reception portion provided at an air inlet or air outlet of a cylinder head, which faces the receiving portion.

A third aspect of the present invention proposes the engine valve seat in that the standard electrode potential of the plating layer is set between the electrode potential of the valve seat main body and the electrode potential of the mounting reception portion.

A forth aspect of the present invention proposes an engine cylinder head having a valve seat provided at a mounting reception portion provided at an air inlet or air outlet of the cylinder head, characterized in that a plating layer is formed on a surface of the mounting reception portion.

A fifth aspect of the present invention proposes an engine cylinder head having a valve seat provided at a mounting reception portion provided at an air inlet or air outlet of the cylinder head, characterized in that a plating layer is formed on that surface of the mounting reception portion which faces the valve seat.

A sixth aspect of the present invention proposes the engine cylinder head in that the standard electrode potential of the plating layer is set between the electrode potential of the valve seat and the electrode potential of the mounting reception portion.

A seventh aspect of the present invention proposes an engine cylinder head having a valve seat provided at a mounting reception portion provided at an air inlet or air outlet of the cylinder head, characterized in that plating layers are formed on both the surface of the mounting reception portion and the surface of the valve seat.

An eighth aspect of the present invention proposes an engine cylinder head having a valve seat provided at a mounting reception portion provided at an air inlet or air outlet of the cylinder head, characterized in that a plating layer is formed on that surface of the mounting reception portion which faces the valve seat, and a plating layer is formed on that surface of the valve seat which faces the mounting reception portion of the valve seat.

A ninth aspect of the present invention proposes the engine cylinder head in that a material for the plating layer of the mounting reception portion and a material for the plating layer of the valve seat are provided in such a manner that electrode potentials equal or approximately equal to each other. Alternately, the electrode potential of the aluminum-based cylinder head, the electrode potential of the plating layer of the mounting reception portion, the electrode potential of the plating layer of the valve seat, and the electrode potential of the iron-based valve seat, increase in that order.

A tenth aspect of the present invention proposes an engine valve seat with an insulating layer formed on a surface of a valve seat main body provided at a mounting reception portion provided at an air inlet or air outlet of a cylinder head, characterized in that the valve seat main body is made of an iron-based alloy, and the insulating layer is an iron oxide film.

An eleventh aspect of the present invention proposes an engine valve seat with an insulating layer formed on that surface of a valve seat main body, provided at a mounting reception portion provided at an air inlet or air outlet of a cylinder head, which faces the mounting reception portion, characterized in that the valve seat main body is made of an iron-based alloy, and the insulating layer is an iron oxide film.

A twelfth aspect of the present invention proposes a method of manufacturing a valve seat provided at a mounting reception portion provided at an air inlet or air outlet of a cylinder head, characterized in that after an insulating layer is formed on an entire surface of a valve seat main body, the valve seat main body is mounted in the mounting reception portion after which the insulating layer on a seat surface of the valve seat main body is removed, and the seat surface is processed.

A thirteenth aspect of the present invention proposes the valve seat manufacturing method having the steps of making the valve seat main body of an iron-based alloy, and an iron oxide film is formed as the insulating layer by steaming the surface of the valve seat main body.

A fourteenth aspect of the present invention proposes an engine valve seat with a coating layer for electrical insulation formed on a surface of a valve seat main body provided at a mounting reception portion provided at an air inlet or air outlet of a cylinder head.

A fifteenth aspect of the present invention proposes an engine valve seat with a coating layer for electrical insulation formed on at least that surface of a valve seat main body, provided at a mounting reception portion provided at an air inlet or air outlet of a cylinder head, which faces the mounting reception portion.

A sixteenth aspect of the present invention proposes an engine cylinder head having a valve seat provided at a mounting reception portion provided at an air inlet or air outlet of a cylinder head, characterized in that a coating layer for electrical insulation is formed on the surface of the concaved mounting reception portion.

A seventeenth aspect of the present invention proposes the engine valve seat in that the coating layer is a ceramic coating layer.

An eighteenth aspect of the present invention proposes the engine cylinder head wherein the coating layer is a ceramic coating layer.

An nineteenth aspect of the present invention proposes the engine valve seat in that the coating layer is a polytetrafluoroethylene resin layer.

A twentieth aspect of the present invention proposes the engine cylinder head according to claim 16, characterized in that the coating layer is a polytetrafluoroethylene resin layer.

A twenty-first aspect of the present invention proposes the engine cylinder head in that the cylinder head is made of an aluminum alloy, and the coating layer is an alumite treated layer.

### EFFECTS OF THE INVENTION

According to the invention as set forth in the first aspect, because the plating layer provided on the surface of the valve seat main body intervenes between the mounting reception portion of the cylinder head and the valve seat main body, a potential difference between the mounting reception portion and the valve seat main body is reduced through water, thereby preventing galvanic corrosion.

According to the invention as set forth in the second aspect, because the plating layer is provided on at least that surface of the of the valve seat main body which faces the mounting reception portion, the plating layer is provided on that surface where the mounting reception portion of the cylinder head and the valve seat main body possibly contact each other, so that a potential difference between the mounting reception portion and the valve seat main body, thereby preventing galvanic corrosion.

According to the invention as set forth in the third aspect, the plating layer provided on the valve seat reduces a potential difference between the plating layer and the mounting reception portion as much as possible.

According to the invention as set forth in the fourth aspect, because the plating layer provided on the surface of the mounting reception portion intervenes between the mounting reception portion of the cylinder head and the valve seat main body, a potential difference between the mounting reception portion and the valve seat main body is reduced through water, thereby preventing galvanic corrosion.

According to the invention as set forth in the fifth aspect, because the plating layer is provided on that surface of the of the mounting reception portion which faces the valve seat, the plating layer is provided on that surface where the mounting reception portion of the cylinder head and the valve seat possibly contact each other, so that a potential difference between the mounting reception portion and the valve seat, thereby preventing galvanic corrosion.

The invention as set forth in the sixth aspect reduces a potential difference between the plating layer and the valve seat as much as possible.

According to the invention as set forth in the seventh aspect, because the plating layers are provided on both the mounting reception portion of the cylinder head and the valve seat, a potential difference between the mounting reception portion and the valve seat main body is reduced through water, thereby preventing galvanic corrosion.

According to the invention as set forth in the eighth aspect, the plating layers are respectively provided on those surfaces of the mounting reception portion and valve seat which face with each other, a potential difference between the mounting reception portion and the valve seat main body is reduced, thereby preventing galvanic corrosion.

According to the invention as set forth in the ninth aspect, because the plating layers respectively provided on the mounting reception portion and the valve seat are provided in such a manner that the electrode potential of the same or similar material or aluminum-based cylinder head, the electrode potential of the plating layer of the mounting reception portion, the electrode potential of the plating layer of the valve seat, and the electrode potential of the iron-based valve seat increase in that order, a potential difference between the plating layer of the mounting reception portion and the plating layer of the valve seat is reduced as much as possible.

According to the invention as set forth in the tenth aspect, because the insulating layer intervenes between the mounting reception portion of the cylinder head and the valve seat main body, no dissimilar metal contact through water by the mounting reception portion and the valve seat main body occurs, thereby preventing galvanic corrosion.

According to the invention as set forth in the eleventh aspect, the insulating film is provided on that surface where the mounting reception portion of the cylinder head and the valve seat main body possibly contact each other, no dissimilar metal contact by the mounting reception portion and the valve seat main body occurs, thereby preventing galvanic corrosion.

According to the invention as set forth in the twelfth aspect, because removal of the iron oxide film on the seat surface of the valve seat main body and processing of the seat surface can be carried out at the same time, manufacturing without a loss at a manufacturing process is ensured.

The invention as set forth in the thirteenth aspect facilitates formation of the insulating layer as the iron oxide film by seaming.

According to the invention as set forth in the fourteenth aspect, because the coating layer provided on the surface of the valve seat main body intervenes between the mounting reception portion of the cylinder head and the valve seat main body, no dissimilar metal contact through water by the mounting reception portion and the valve seat main body occurs, thereby preventing galvanic corrosion.

According to the invention as set forth in the fifteenth aspect, because the coating layer is provided on at least that surface of the of the valve seat main body which faces the mounting reception portion, the plating layer is provided on that surface where the mounting reception portion of the cylinder head and the valve seat main body possibly contact each other, so that no dissimilar metal contact by the mounting reception portion and the valve seat main body occurs, thereby preventing galvanic corrosion.

According to the invention as set forth in the sixteenth aspect, because the coating layer provided on the mounting reception portion intervenes between the cylinder head and the valve seat, no dissimilar metal contact through water by the mounting reception portion and the valve seat occurs, thereby preventing galvanic corrosion.

According to the invention as set forth in the seventeenth and eighteenth aspects, because the coating layer as the ceramic coating layer intervenes between the mounting reception portion of the cylinder head and the valve seat main body, no dissimilar metal contact through water by the mounting reception portion and the valve seat main body occurs, thereby preventing galvanic corrosion.

According to the invention as set forth in the nineteenth and twentieth aspects, because the coating layer as the polytetrafluoroethylene resin layer intervenes between the mounting reception portion of the cylinder head and the valve seat main body, no dissimilar metal contact through water by the mounting reception portion and the valve seat main body occurs, thereby preventing galvanic corrosion.

According to the invention as set forth in the twenty-first aspect, as the alumite treated layer as the coating layer intervenes between the mounting reception portion of the cylinder head and the valve seat main body, no dissimilar metal contact through water by the mounting reception portion and the valve seat main body occurs, thereby preventing galvanic corrosion.

### BRIEF DESCRIPTION OF THE DRAWINGS

FIG. 1 is a cross-sectional view illustrating an embodiment of the invention.

FIG. 2 is a cross-sectional view of relevant parts illustrating the embodiment as illustrated in FIG. 1 of the invention.

FIG. 3 is an explanatory table of standard electrode potentials illustrating the embodiment of the invention of FIG. 1.

FIG. 4 is a cross-sectional view illustrating another embodiment of the invention.

FIG. 5 is a cross-sectional view of relevant parts illustrating the embodiment as illustrated in FIG. 4 of the invention.

FIG. 6 is a cross-sectional view illustrating a further embodiment of the invention.

FIG. 7 is a cross-sectional view of relevant parts illustrating the embodiment as illustrated in FIG. 6 of the invention.

FIG. 8 is a cross-sectional view illustrating an embodiment of the invention.

FIG. 9 is a cross-sectional view of relevant parts illustrating the fourth embodiment as illustrated in FIG. 8 of the invention.

FIG. 10 is a cross-sectional view of the manufacturing step illustrating the embodiment as illustrated in FIG. 8 of the invention.

FIG. 11 is a cross-sectional view of relevant parts of the manufacturing step illustrating the embodiment as illustrated in FIG. 8 of the invention.

FIG. 12 is a perspective view of the examination of the iron oxide films by a steam treatment.

FIG. 13 is a cross-sectional view illustrating another embodiment of the invention.

FIG. 14 is a cross-sectional view of relevant parts illustrating the embodiment of the invention as illustrated in FIG. 13.

FIG. 15 is a cross-sectional view illustrating a further embodiment of the invention.

FIG. 16 is a cross-sectional view of relevant parts illustrating the embodiment of the invention as illustrated in FIG. 15.

### DETAILED DESCRIPTION OF THE INVENTION

Individual embodiments of an engine valve seat, manufacturing method thereof, and engine cylinder head according to the invention will be explained below.

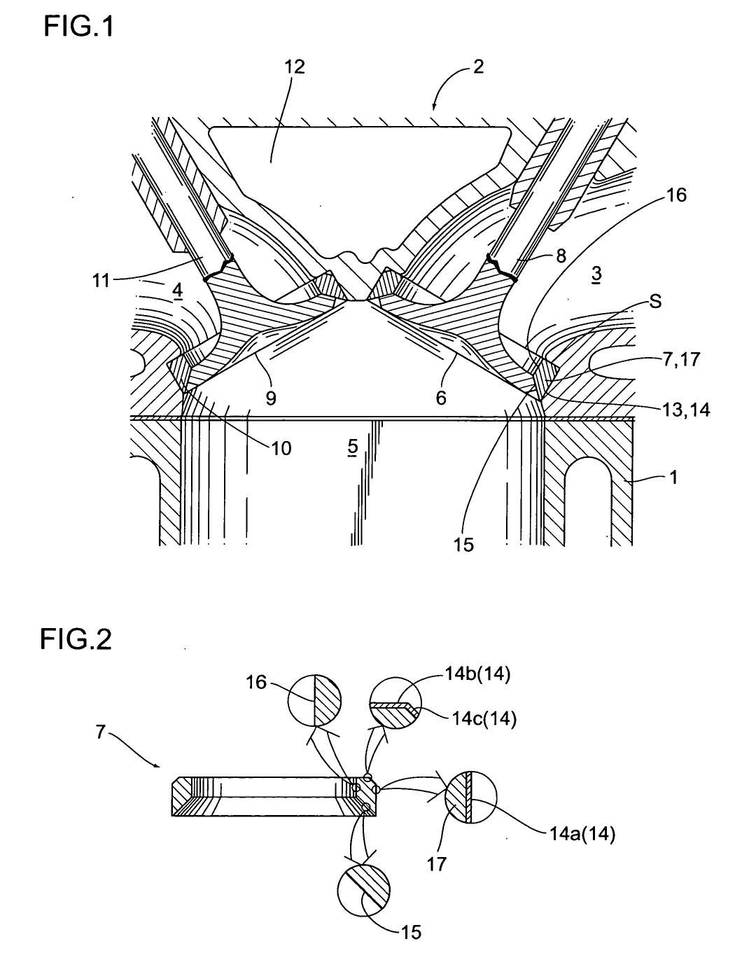

FIGS. 1 to 3 illustrate an embodiment, and a cylinder head 2 fixed to a cylinder 1 in which a non-illustrated piston reciprocates, is made of an aluminum alloy, and has an intake port 3 provided on the one side thereof, and an exhaust port 4 on the other side thereof. An air inlet 6 of the intake port 3 that faces a combustion chamber 5 is provided with an intake valve seat 7 which is opened and closed by an intake valve 8. Likewise, an air outlet 9 of an exhaust port 4 that faces the combustion chamber 5 is provided with an exhaust valve seat 10 which is opened and closed by an exhaust valve 11. The cylinder head 2 further has a cooling channel 12 provided between the intake port 3 and the exhaust port 4.

A mounting reception portion 13 for the intake valve seat 7 is provided at the air inlet 6. The mounting reception portion 13 is so formed in a concaved manner as to have a slightly larger diameter than the diameter of the intake port 3, and the intake valve seat 7 is fitted into the mounting reception portion 13.

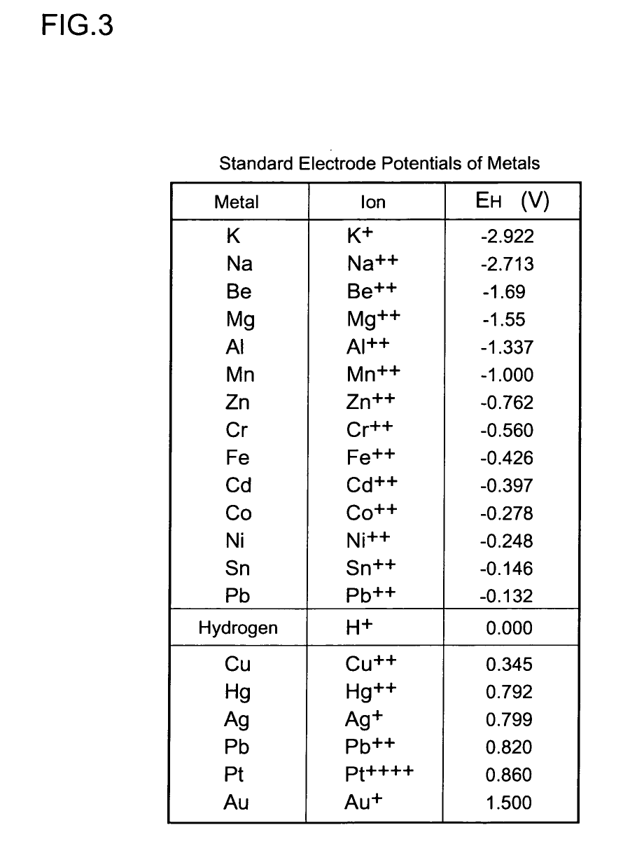

The iron-based intake valve seat 7 is formed in a ring-like shape in such a way that its external diameter is the same size as the diameter of the mounting reception portion 13, and its internal diameter is the same size as the diameter of the intake port 3, and is made of an iron-based sintered alloy. That surface of the intake valve seat 7 which faces the mounting reception portion is covered with a plating layer 14. The standard electrode potential of the plating layer 14 is set between the electrode potential of a later-described valve seat main body 17 and the electrode potential of the mounting reception portion 13. That is, an electrode potential is a voltage between an electrode and a solution or electrolyte in which the electrode is soaked, and is normally compared with a standard electrode like a hydrogen electrode. FIG. 3 illustrates standard electrode voltages of metals. The standard electrode potential (E_{H}) of the cylinder 2 made of an aluminum alloy is almost −1.3 V or so because the standard electrode voltage (E_{H}) of aluminum is −1.337 V, and the standard electrode potential of the iron-based valve seat main body 17 is −0.42 V or so, so that it is preferable that the plating layer 14 should be made of an aluminum or aluminum alloy whose standard electrode potential becomes almost the same as that of the mounting reception portion 12, Zn (standard electrode potential is −0.76 V or so) or Cr (standard electrode potential is −0.56 V or so) whose standard electrode potential is set in the middle, or Al—Zn, Cr-based composite plating, or Zn-based composite plating. Meanwhile, the Cr-based composite plating is a plating in which ceramic particles of Al₂O₃ or the like, or resin particles of PTFE (PolyTetraFluoroEthylene) or the like in a metallic plating film are dispersed, and has both corrosion resistance and wear resistance. Its thickness is 50 angstroms to 100 μm, and preferably 1 to 100 μm, and is formed on an outer periphery portion 14a formed at the outer periphery surface of the intake valve seat 7 and an abutment portion 14b located at the intake port 3 side, as well as a chamfered angle portion 14c formed at the edge at the mounting reception portion 13 side. The surface of the intake valve seat 7 which faces the combustion chamber 5 is tapered with the intake valve 8 being the shaft center and is formed as a seat surface 15, and the plating layer 14 is not formed on the seat surface 15, and an inner periphery surface 16 may be or may not be provided with the plating layer 14.

Next, an intake valve seat manufacturing method and an attaching method will be explained. With respect to the intake valve seat 7, mixed well with Fe powders are all of or part of Fe—Si powders, Ni powders, Co powders, Fe—W powders, Fe—Cr powders, Cu powders, Fe—Nb powders, Fe—V powders, and C powders, powder compacting by molds is performed on the obtained mixed powders, and the obtained mold powder compacting body is sintered under a normal condition, thereby manufacturing the valve seat main body 17 with an ingredient composition substantially the same as the mixture composition.

The plating layer 14 is formed on the outer periphery portion 14a, abutment portion 14b, and the chamfered angle portion 14c of the valve seat main body 17. Next, the intake valve seat 7 is mounted in the cylinder head 2. This mounting is carried out by press, shrink fit, or expansion fit of the intake valve seat 7 to the mounting reception portion 13. Next, the seat surface 15 is machined in such a way that the intake valve 8 closely contacts the seat surface 15 of the mounted intake valve seat 7.

Next, the effect of the above-described structure will be explained. When an engine fuel essentially consisting of alcohol which may contain a relatively large amount of water is introduced in the cylinder 1 together with air through the intake port, if the water penetrates a clearance S between the intake valve seat 7 and the mounting reception portion 13 and remains there, the cylinder head 2 and the intake valve seat 7 contact each other through the water, and this results in dissimilar metal contact, so that galvanic corrosion may occur. The plating layer 14 which is made of the same or homogeneous material as that of the cylinder head 2 is, however, formed on that surface of the intake valve seat main body 17 which faces the mounting reception portion 13, thus preventing occurrence of galvanic corrosion.

As explained above, according to the embodiment, as the plating layer 14 is formed on the surface of the iron-based valve seat main body 17 provided at the mounting reception portion 13 formed at the air inlet 6 of the cylinder head 2 made of an aluminum alloy, the plating layer 14 intervenes between the cylinder head 2 and the valve seat main body 17, a potential difference between the dissimilar metals for the mounting reception portion 13 and the valve seat main body 17 is reduced through water, thereby preventing galvanic corrosion.

Because the plating layer 14 is provided on at least that surface of the valve seat main body which faces the mounting reception portion 13, the plating layer 14 is provided on the surface of valve seat main body 17 which can contact the mounting reception portion 13, and the potential difference between the dissimilar metals for the mounting reception portion 13 and the valve seat main body 17 is reduced, thereby preventing galvanic corrosion.

Further, as the electrode potential of the plating layer 14 provided on the valve seat main body 17 is almost the same as the electrode potential of the mounting reception portion 13, or is set between the electrode potential of the valve seat main body 17 and the electrode potential of the mounting reception portion 13, so that the potential difference between the plating layer 14 and the mounting reception portion 13 is reduced.

Other embodiments are explained below. For the other embodiments, the same portions as the above embodiment are denoted by the same reference numerals to omit their detailed explanations.

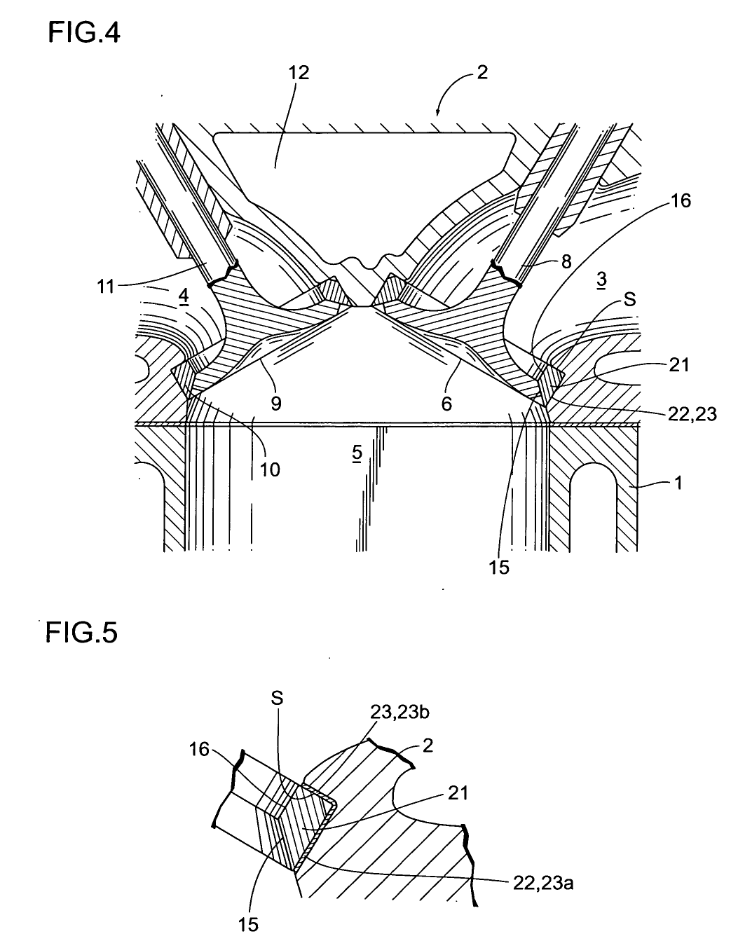

FIGS. 4 and 5 illustrate another embodiment. Provided at the air inlet 6 formed at the cylinder head 2 is a mounting reception portion 22 for an intake valve seat 21, and the intake valve seat 21 is fitted into the mounting reception portion 22. The intake valve seat 21 is made of an iron-based sintered alloy, and is formed in a ring-like shape in such a way that its external diameter is the same size as the diameter of the mounting reception portion 22, and its internal diameter is the same size as the diameter of the intake port 3.

The mounting reception portion 22 is provided with a plating layer 23. The plating layer 23 is formed on the surfaces opposite to the intake valve seat 21, i.e., formed on an inner periphery surface portion 23a and a bottom surface portion 23b. The electrode potential of the plating layer 23 is set between the electrode potential of the valve seat 21 and the electrode potential of the mounting reception portion 22. That is, the standard electrode potential (E_{H}) of the cylinder 2 made of an aluminum alloy is −1.3 V or so, and the standard electrode potential of the iron-based valve seat 21 is −0.42 V or so, so that it is preferable that the plating layer 23 should be made of Zn (standard electrode potential is −0.76 V or so), Cr (standard electrode potential is −0.56 V or so) whose standard electrode potentials are set in the middle, or Al—Zn, Cr-based composite plating, or Zn-based composite plating.

Therefore, when an engine fuel essentially consisting of alcohol which may contain a relatively large amount of water is introduced in the cylinder 1 together with air through the intake port, if the water penetrates the clearance S between the intake valve seat 7 and the mounting reception portion 13 and remains there, the cylinder head 2 and the intake valve seat 7 contact each other through the water, and this results in dissimilar metal contact, so that galvanic corrosion may occur. As the plating layer 23 which reduces the electrode difference is formed on the surface of the mounting reception portion 22, however, occurrence of galvanic corrosion is suppressed.

As explained above, in the embodiment, as the plating layer 23 is formed on the mounting reception portion 23 provided at the air inlet 6 of the cylinder head 2 made of an aluminum alloy and the valve seat 21 is provided through the plating layer 23, the plating layer 23 intervenes between the cylinder head 2 and the valve seat 21, the potential difference originating from dissimilar metal contact between the mounting reception portion 22 and the valve seat 21 is reduced, thereby ensuring prevention of galvanic corrosion.

Because the plating layer 23 is provided on that surface of the mounting reception portion 22 which faces the valve seat 21, the plating layer 23 is provided on the surface of the mounting reception portion 22 which possibly contacts the valve seat 21, and the potential difference between the dissimilar metals for the mounting reception portion 22 and the valve seat 21 is reduced, thereby preventing galvanic corrosion.

Further, as the electrode potential of the plating layer 23 provided on the valve seat 21 is set between the electrode potential of the valve seat 21 and the electrode potential of the mounting reception portion 22, so that the potential difference between the plating layer 23 and the mounting reception portion 22 is possibly reduced.

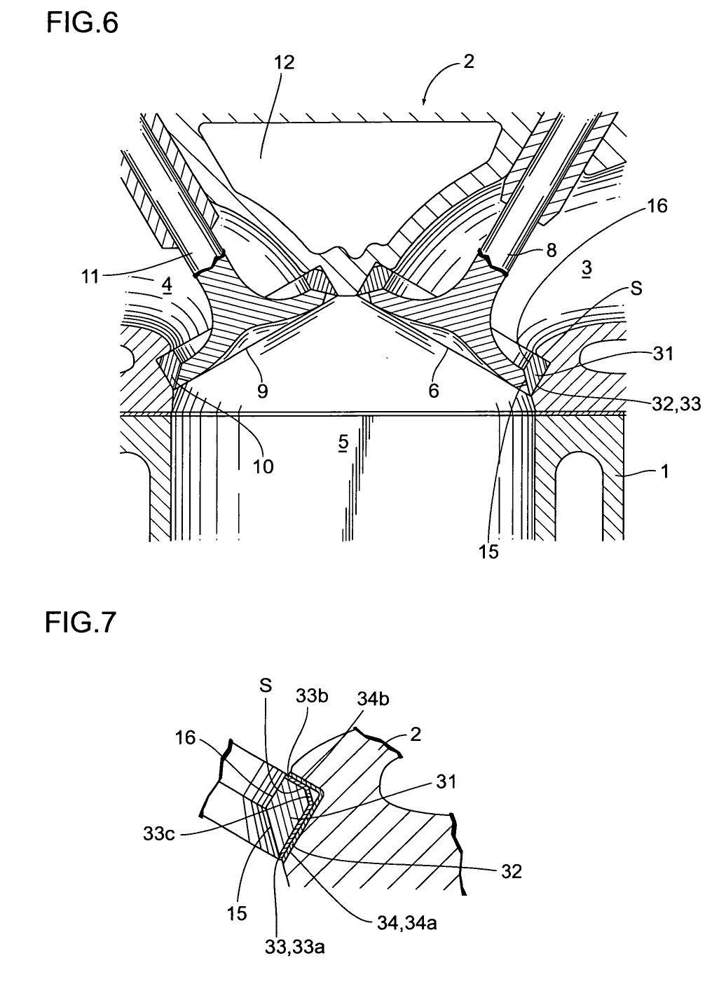

FIGS. 6 and 7 illustrate a further embodiment. Provided at the air inlet 6 formed at the cylinder head 2 is a mounting reception portion 32 for an intake valve seat 31, and the intake valve seat 31 is fitted into the mounting reception portion 32. The intake valve seat 31 is made of an iron-based sintered alloy, and is formed in a ring-like shape in such a way that its external diameter is the same size as the diameter of the mounting reception portion 22, and its internal diameter is the same size as the diameter of the intake port 3.

Plating layers 33, 34 are respectively provided on that surface of the valve seat 31 which faces the mounting reception portion 32, and that surface of the mounting reception portion 32 which faces the valve seat 31. The plating layer 33 is formed on an outer periphery portion 33a formed at the outer surface of the intake valve seat 31 and an abutment portion 34b located at the intake port 3 side, as well as a chamfered angle portion 33c formed at the edge at the mounting reception portion 32 side. The plating layer 34 is provided on the surface opposite to the intake valve seat 31, that is, an inner periphery surface portion 34a and a bottom surface portion 34b, and the materials of the plating layers 33, 34 are the same or similar materials so that electrode potentials becomes the same or approximately the same. The materials of the plating layers 33, 34 are provided in such a manner that the electrode potential of the cylinder head 2 made of an aluminum alloy (−1.33 V), the electrode potential of the Zn-based plating layer 34 of the mounting reception portion 34 (−0.76 V), the electrode potential of the Cr-based plating layer 33 of the valve seat 33 (−0.56 V), and the electrode potential of the iron-based valve seat 33 (−0.42 V), increase in that order.

Therefore, when an engine fuel essentially consisting of alcohol which may contain a relatively large amount of water is introduced in the cylinder 1 together with air through the intake port, if the water penetrates a clearance S between the intake valve seat 31 and the mounting reception portion 33 and remains there, the cylinder head 2 and the intake valve seat 31 contact each other through the water, and this results in dissimilar metal contact, so that galvanic corrosion may occur. As the plating layers 33, 34 which reduce the electrode difference are formed on the surfaces of the mounting reception portion 32, however, occurrence of galvanic corrosion is suppressed.

As explained above, according to the embodiment, as the plating layers 33, 34 are respectively formed on the valve seat 31 and the mounting reception portion 32, the plating layers 33, 34 are present between the cylinder head 2 and the valve seat 31, the potential difference originating from dissimilar metal contact between the mounting reception portion 32 and the valve seat 31 is reduced, thereby ensuring prevention of galvanic corrosion.

The plating layers 33, 34 are made of the same or similar materials, and provided in such a manner that the electrode potential of the aluminum-based cylinder head, the electrode potential of the plating layer of the mounting reception portion, the electrode potential of the plating layer of the valve seat, and the electrode potential of the iron-based valve seat, increase in that order, thus possibly reducing the potential difference between the plating layers 33 and 34.

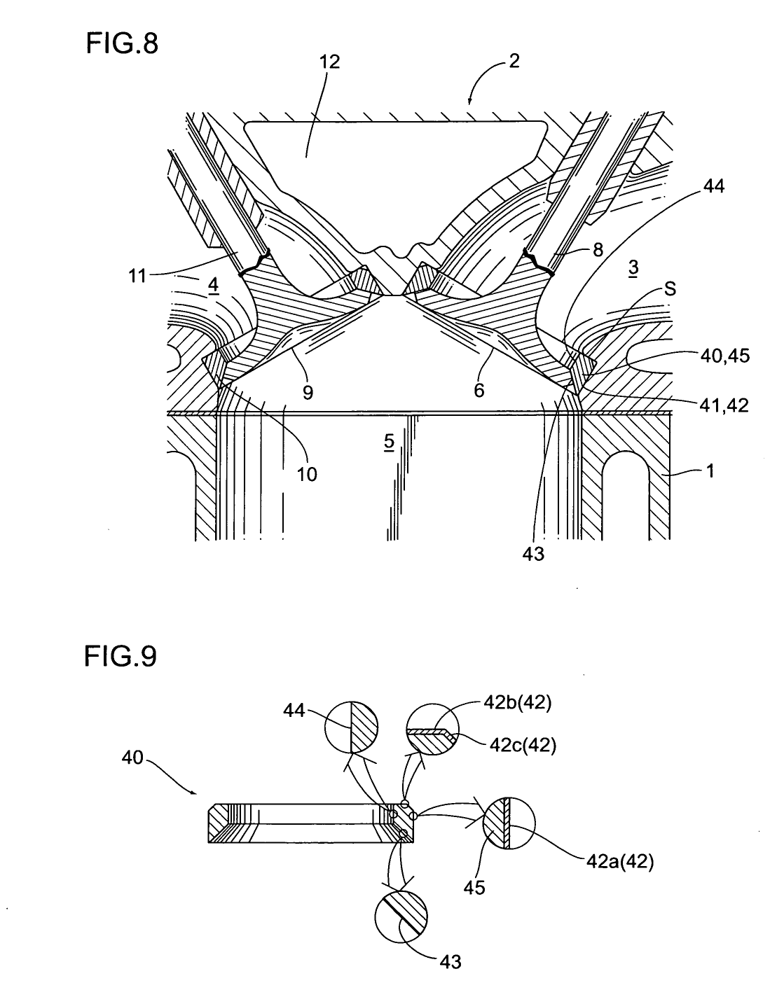

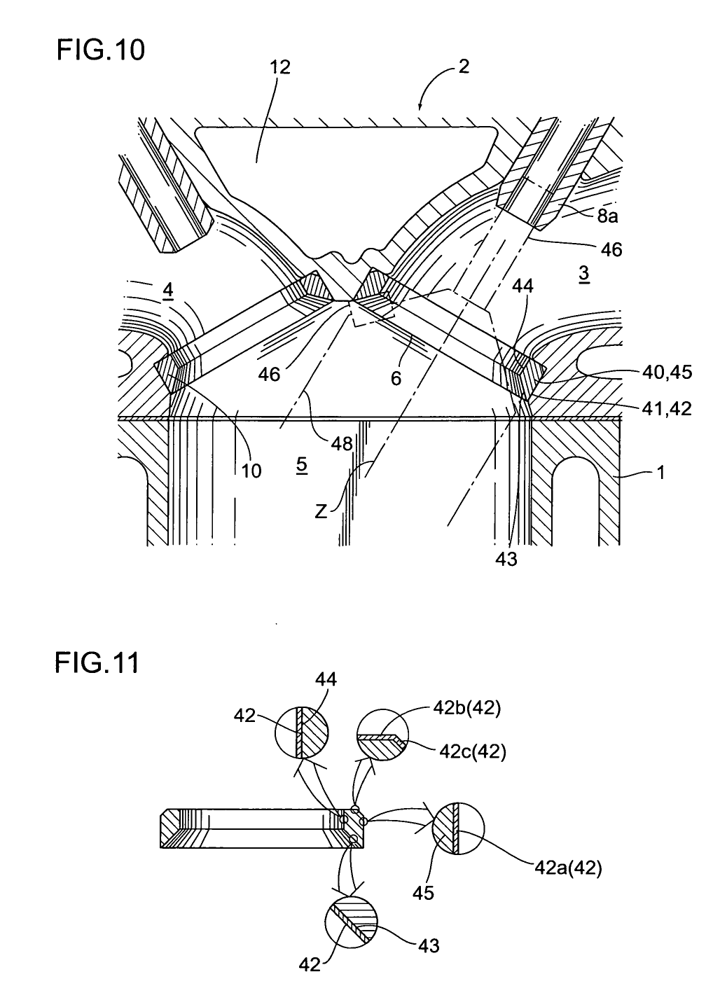

FIGS. 8 to 12 illustrate another embodiment. The air inlet 6 of the intake port 3 that faces the combustion chamber 5 is provided with an intake valve seat 40 which is opened and closed by the intake valve 8. A mounting reception portion 41 for the intake valve seat 40 is provided at the air inlet 6. The mounting reception portion 41 is so formed in a concaved manner as to have a slightly larger diameter than the diameter of the intake port 3, and the intake valve seat 40 is fitted into the mounting reception portion 41.

The intake valve seat 40 is formed in a ring-like shape in such a way that its external diameter is the same size as the diameter of the mounting reception portion 41, and its internal diameter is the same size as the diameter of the intake port 3. That surface of the intake valve seat 40 which faces the mounting reception portion 41 is covered with an iron oxide film 42 which is essentially composed of Fe₃O₄ as an insulating layer by a seam (vapor) treatment. The iron oxide film 42 has a thickness of 1 to 50 μm, preferably 3 to 20 μm, and is formed on an outer periphery portion 42a formed at the outer periphery surface of the intake valve seat 40 and an abutment portion 42b located at the intake port 3 side, as well as a chamfered angle portion 42c formed at the edge at the mounting reception portion 41 side. The surface of the intake valve seat 7 which faces the combustion chamber 5 is tapered with the intake valve 8 being the shaft center and is formed as a seat surface 43, and the iron oxide film is not formed on the seat surface 43, and an inner periphery surface 44 may be or may not be provided with the iron oxide film.

Next, an intake valve seat manufacturing method will be explained. With respect to the intake valve seat 40, mixed well with Fe powders are all of or part of Fe—Si powders, Ni powders, Co powders, Fe—W powders, Fe—Cr powders, Cu powders, Fe—Nb powders, Fe—V powders, and C powders, powder compacting by molds is performed on the obtained mixed powders, and the obtained mold powder compacting body is sintered under a normal condition, thereby manufacturing the valve seat main body 45 with an ingredient composition substantially the same as the mixture composition. If needed, press work by a correcting press is carried out, and a valve seat main body 45 is manufactured.

Further, a steam treatment at a predetermined temperature in a range of, for example, 500 to 550° C. is performed on those valve seat main bodies 45 for 30 to 120 minutes, and the iron oxide film 42 is formed on the outer periphery portion 42a, the abutment portion 42b, the chamfered angle portion 42c, as well as the seat surface 43 and the inner periphery surface 44. The iron oxide film 42 has characteristics such that the density is 6.8 g/cm³, the hardness HRB is 50, the tensile strength is 400 N/mm², and the elongation is 1.5%.

Next, the intake valve seat 40 is mounted in the cylinder head 2. This mounting is carried out by press, shrink fit, or expansion fit of the intake valve seat 40 to the mounting reception portion 41. Next, the seat surface 43 of the mounted intake valve seat 40 is machined in such a manner as to closely contact the intake valve 8. This machining is carried out with a cutting tool 48 that integrally has an intake valve guide cutting portion 46 and a valve seat cutting portion 47 which respectively perform coaxial cutting to valve guides 8a and valve seats 40 of the intake valves 8 plurally provided at the cylinder head 2, and this tool is rotated around the Z axis, so that the intake valve guide cutting portion 46 machines the inner periphery surface of the valve guide 8a and the valve seat cutting portion 47 eliminates the iron oxide film 42 on the seat surface 43 at the same time.

Next, the effect of the above-described structure will be explained. When an engine fuel essentially consisting of alcohol which may contain a relatively large amount of water is introduced in the cylinder 1 together with air through the intake port 3, if the water penetrates a clearance S between the intake valve seat 40 and the mounting reception portion 41 and remains there, the cylinder head 2 and the intake valve seat 40 contact each other through the water, and this results in dissimilar metal contact, so that galvanic corrosion may occur. As the iron oxide film 42, which has an electrical insulation property is formed on that surface of the intake valve seat main body 45 which faces the mounting reception portion 41, however, occurrence of galvanic corrosion is suppressed.

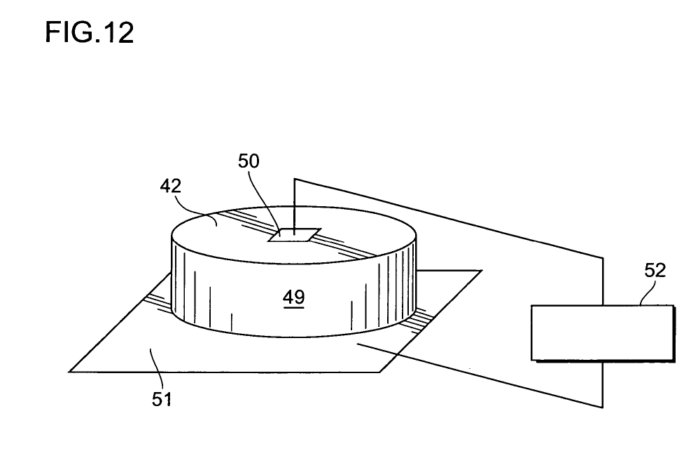

Next, regarding an examination for iron oxide films by a steam treatment will be explained with reference to FIG. 12. In the examination, an iron-based sintered body 49 having a 60 mm diameter and a 20 mm thickness with iron oxide films 42 formed on both surfaces by a steam treatment, and one without an iron oxide film were prepared, one electrode 50 was provided on one surface of each test piece and other electrode 51 was provided by providing a piece of copper sheet on the other surface, an insulation resistance meter 52 was connected between both electrodes, and a resistance was measured. As a result, the resistance of one without an iron oxide film was 0.3 to 1.0Ω, while the resistance of the other with the iron oxide films 42 was 10 to 40Ω, and electrical insulation was confirmed.

As explained above, according to the embodiment, as the iron oxide film 42 is formed on the surface of the iron-based valve seat main body 45 provided at the mounting reception portion 41 formed at the air inlet 6 of the cylinder head 2 made of an aluminum alloy, the iron oxide film 42 intervenes between the cylinder head 2 and the valve seat main body 45, no dissimilar metal contact through water by the mounting reception portion 41 and the valve seat main body 45 occurs, thus preventing galvanic corrosion.

Because the iron oxide film 42 is provided on at least that surface of the valve seat main body which faces the mounting reception portion 41, the iron oxide film 42 is provided on the surface of the valve seat main body 45 which possibly contacts mounting reception portion 41, no dissimilar metal contact by the mounting reception portion 41 and the valve seat main body 45 occurs, thus preventing galvanic corrosion.

Further, as the valve seat main body 45 is made of an iron-based alloy and the insulating layer is the iron oxide film 42, formation of the insulating layer is relatively easy.

As the valve seat main body 45 is mounted in the mounting reception portion 41 after the iron oxide film 42 as the insulating layer is formed on the entire surface of the valve seat main body 45, and then the iron oxide film 42 on the seat surface 43 of the valve seat main body 45 is removed and the seat surface 43 is processed, the valve seat main body 45 with the iron oxide film 42 on the entire surface can be directly mounted in the mounting reception portion 41, and the iron oxide film 42 on the seat surface 43 can be removed when the seat surface 43 is processed in a shape coaxial to the valve 8, so that elimination of the iron oxide film 42 on the seat surface 43 and the finish processing of the seat surface 43 can be carried out together, thereby ensuring manufacturing without a loss during a manufacturing process.

As the valve seat main body 45 is made of an iron-based alloy, and a steam treatment is applied to its surface to form the iron oxide film 42 as the insulating layer, formation of the insulating layer is relatively easy.

### FIFTH EMBODIMENT

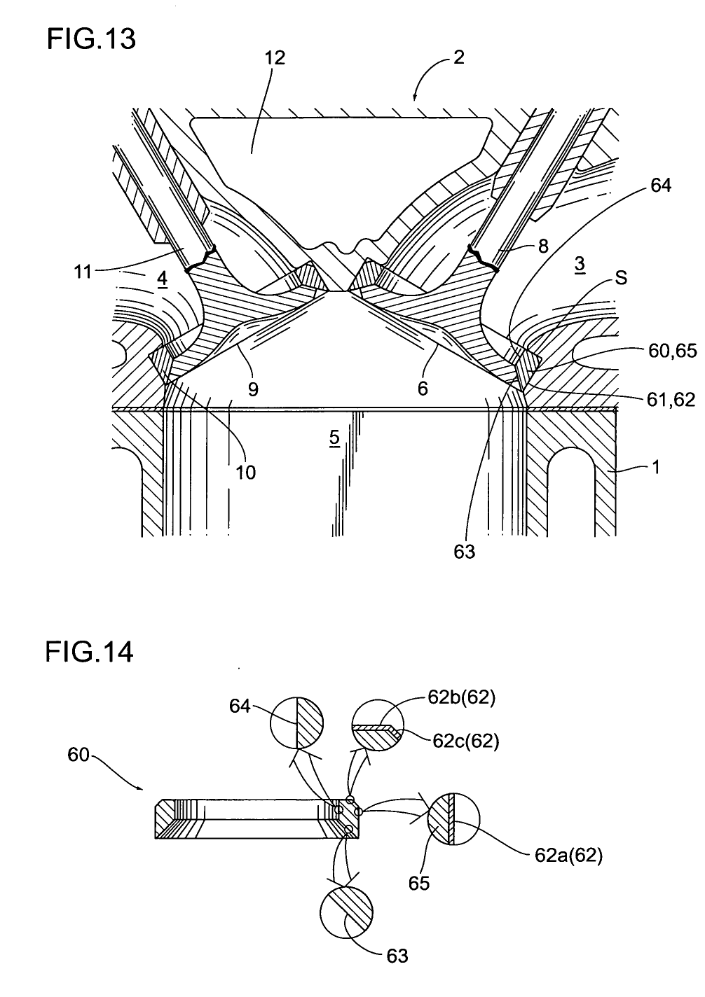

FIGS. 13 and 14 illustrate a further embodiment. The air inlet 6 of the intake port 3 that faces the combustion chamber 5 is provided with an intake valve seat 60 which is opened and closed by the intake valve 8. A mounting reception portion 61 for the intake valve seat 60 is provided at the air inlet 6. The mounting reception portion 13 is so formed in a concaved manner as to have a slightly larger diameter than the diameter of the intake port 3, and the intake valve seat 60 is fitted into the mounting reception portion 61.

The intake valve seat 60 is formed in a ring-like shape in such a way that its external diameter is the same size as the diameter of the mounting reception portion 61, and its internal diameter is the same size as the diameter of the intake port 3, and is made of an iron-based sintered alloy. That surface of the intake valve seat 60 which faces the mounting reception portion 61 is covered with a ceramic coating layer 62 for electric insulation. The ceramic coating layer 62 is formed by vapor coating technique, such as plasma CVD (Chemical Vapor Deposition), or ion plating, and is, for example, a PVD coating of Diamond-Like Carbon (DLC), TiCN, or TiAlN, or a CVD coating of Al₂O₃, SiC, Si₃N₄, or Al₂O₃, and its thickness is 50 angstroms to 100 μm, and preferably 1 to 50 μm, and is formed on an outer periphery portion 62a formed at the outer periphery surface of the intake valve seat 60 and an abutment portion 62b located at the intake port 3 side, as well as a chamfered angle portion 62c formed at the edge at the mounting reception portion 61 side. The surface of the intake valve seat 60 which faces the combustion chamber 5 is tapered with the intake valve 8 being the shaft center and is formed as a seat surface 63, and the coating layer 62 is not formed on the seat surface 63, and an inner periphery surface 16 may be or may not be provided with the coating layer 62.

Next, an intake valve seat manufacturing method and an attaching method will be explained. With respect to the intake valve seat 60, mixed well with Fe powders are all of or part of Fe—Si powders, Ni powders, Co powders, Mo powders, Fe—W powders, Fe—Cr powders, Cu powders, Fe—Nb powders, Fe—V powders, and C powders, powder compacting by molds is performed on the obtained mixed powders, and the obtained mold powder compacting body is sintered under a normal condition, thereby manufacturing the valve seat main body 65 with an ingredient composition substantially the same as the mixture composition.

The coating layer 62 is formed on the outer periphery portion 62a, abutment portion 62b, and chamfered angle portion 62c of the valve seat main body 65. Next, the intake valve seat 60 is mounted in the cylinder head 2. This mounting is carried out by press, shrink fit, or expansion fit of the intake valve seat 60 to the mounting reception portion 61. Next, the seat surface 63 is machined in such a way that the intake valve 8 closely contacts the seat surface 63 of the mounted intake valve seat 60.

Next, the effect of the above-described structure will be explained. When an engine fuel essentially consisting of alcohol which may contain a relatively large amount of water is introduced in the cylinder 1 together with air through the intake port, if the water penetrates a clearance S between the intake valve seat 60 and the mounting reception portion 61 and remains there, the cylinder head 2 and the intake valve seat 60 contact each other through the water, and this results in dissimilar metal contact, so that galvanic corrosion may occur. As the coating layer 62 for electrical insulation is formed on that surface of the intake valve seat main body 65 which faces the mounting reception portion 61, however, occurrence of galvanic corrosion is prevented.

As explained above, according to the embodiment, as the coating layer 62 for electrical insulation is formed on the surface of the iron-based valve seat main body 63 provided at the mounting reception portion 61 formed at the air inlet 6 of the cylinder head 2 made of an aluminum alloy, the coating layer 62 intervenes between the cylinder head 2 and the valve seat main body 65, no dissimilar metal contact through water by the mounting reception portion 13 and the valve seat main body 65 occurs, thus preventing galvanic corrosion.

Because the coating layer 62 is provided on at least that surface of the valve seat main body 65 which faces the mounting reception portion 61, the coating layer 62 is provided on the surface of the valve seat main body 65 which possibly contacts the mounting reception portion 61, no dissimilar metal contact by the mounting reception portion 61 and the valve seat main body 65 occurs, thus preventing galvanic corrosion.

Furthermore, as the coating layer 62 is made of ceramic, electrical insulation between the cylinder head 2 and the valve seat main body 65 can be ensured.

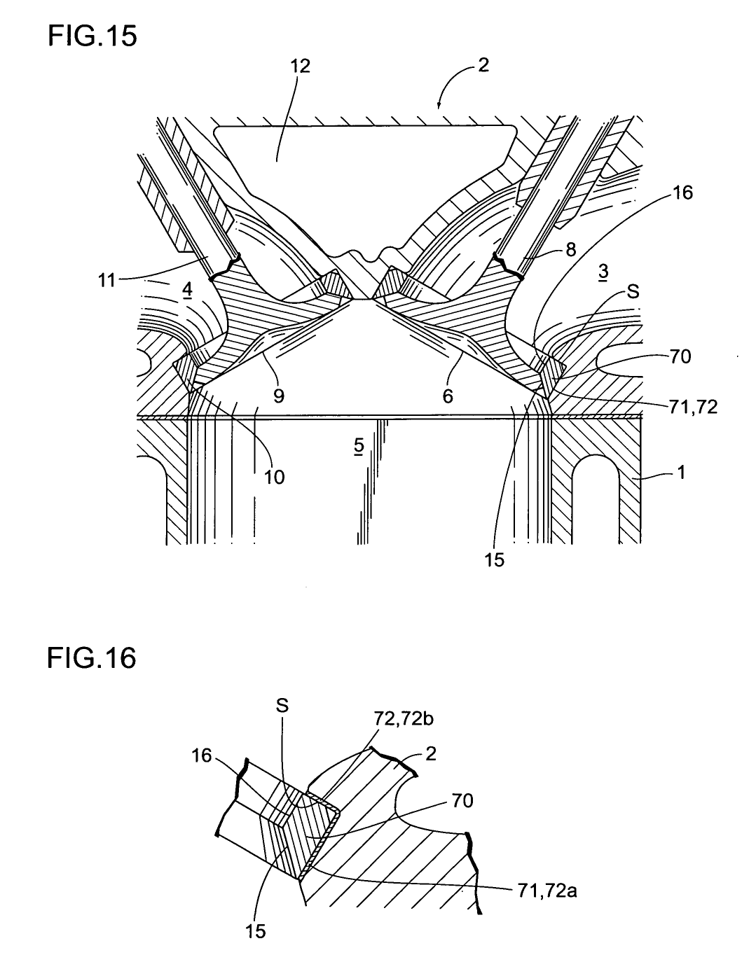

FIGS. 15 and 16 illustrate another embodiment. Provided at the air inlet 6 formed at the cylinder head 2 is a mounting reception portion 70 for an intake valve seat 70, and the intake valve seat 70 is fitted into the mounting reception portion 71. The intake valve seat 21 is made of an iron-based sintered alloy, and is formed in a ring-like shape in such a way that its external diameter is the same size as the diameter of the mounting reception portion 71, and its internal diameter is the same size as the diameter of the intake port 3.

A coating layer 72 made of a ceramic for electrical insulation similar to the fifth embodiment is provided at the mounting reception portion 71. The coating layer 72 is provided on the surfaces opposing to the intake valve seat 70, that is, an inner periphery surface portion 72a and a bottom surface portion 72b.

Therefore, when an engine fuel essentially consisting of alcohol which may contain a relatively large amount of water is introduced in the cylinder 1 together with air through the intake port, if the water penetrates a clearance S between the intake valve seat 70 and the mounting reception portion 71 and remains there, the cylinder head 2 and the intake valve seat 7 contact each other through the water, and this results in dissimilar metal contact, so that galvanic corrosion may occur. As the coating layer 72 for electrical insulation is formed on the surfaces of the mounting reception portion 71, however, occurrence of galvanic corrosion is prevented.

As explained above, according to the embodiment, as the coating layer 72 is formed at the mounting reception portion 71 formed at the air inlet 6 of the cylinder head 2 made of an aluminum alloy, and the iron-based valve seat 70 is provided via the coating layer 72, the coating layer 72 made of a ceramic intervenes between the cylinder head 2 and the valve seat 70, no dissimilar metal contact by the mounting reception portion 71 and the valve seat 70 occurs, thus preventing galvanic corrosion.

Because the coating layer 72 is provided on that surface of the mounting reception portion 71 which faces the valve seat 70, the coating layer 72 is provided on the surface of the mounting reception portion 71 which possibly contacts the valve seat 70, no dissimilar metal contact by the mounting reception portion 72 and the valve seat 70 occurs, thus preventing galvanic corrosion.

Furthermore, as the coating layer 72 is made of ceramic, electrical insulation between the cylinder head 2 and the valve seat 70 can be ensured.

In an embodiment, the coating layer of the valve seat of one of the previous embodiments is formed by a PolyTetraFluoroEthylene (PTFE) resin layer, instead of ceramic. The polytetrafluoroethylene resin layer has superior characteristics, such as an electrical insulating property, and a fire resistance.

Therefore, when an engine fuel essentially consisting of alcohol which may contain a relatively large amount of water is introduced in a cylinder together with air through an intake port, if the water penetrates a clearance between an intake valve seat and a mounting reception portion and remains there, a cylinder head and the intake valve seat contact each other through the water, and this results in dissimilar metal contact, so that galvanic corrosion may occur. As the polytetrafluoroethylene resin layer for electrical insulation is formed on the intake valve seat, however, occurrence of galvanic corrosion is prevented.

As explained above, formation of the polytetrafluoroethylene resin layer according to the embodiment does not cause dissimilar metal contact between the cylinder head and the valve seat, so that galvanic corrosion can be prevented.

The coating layer in another embodiment of the mounting reception portion of the previous embodiment is formed by a PolyTetraFluoroEthylene (PTFE) resin layer, instead of ceramic. The polytetrafluoroethylene resin layer has superior characteristics, such as an electrical insulating property, and a fire resistance.

Therefore, when an engine fuel essentially consisting of alcohol which may contain a relatively large amount of water is introduced in a cylinder together with air through an intake port, if the water penetrates a clearance between an intake valve seat and a mounting reception portion and remains there, a cylinder head and the intake valve seat contact each other through the water, and this results in dissimilar metal contact, so that galvanic corrosion may occur. As the polytetrafluoroethylene resin layer for electrical insulation is formed on the intake valve seat, however, occurrence of galvanic corrosion is prevented.

As explained above, formation of the polytetrafluoroethylene resin layer according to the embodiment does not cause dissimilar metal contact between the cylinder head and the valve seat, so that galvanic corrosion can be prevented.

In a further embodiment, the coating layer of the mounting reception portion provided at the cylinder head 2 made of an aluminum alloy in the sixth embodiment is formed by an alumite treated layer (anodized layer) for electrical insulation, instead of ceramic.

Therefore, when an engine fuel essentially consisting of alcohol which may contain a relatively large amount of water is introduced in a cylinder together with air through an intake port, if the water penetrates a clearance between an intake valve seat and a mounting reception portion and remains there, a cylinder head and the intake valve seat contact each other through the water, and this results in dissimilar metal contact, so that galvanic corrosion may occur. As the alumite treated layer for electrical insulation is formed on the intake valve seat, however, occurrence of galvanic corrosion is prevented.

As explained above, formation of the alumite treated layer according to the embodiment does not cause dissimilar metal contact between the cylinder head and the valve seat, so that galvanic corrosion can be prevented.

1. An engine valve seat comprising a plating layer formed on a surface of a valve seat main body fitted into a concaved mounting reception portion provided at an air inlet or air outlet of a cylinder head, thus preventing galvanic corrosion originating from dissimilar metal contact with a valve seat at said concaved mounting reception portion of said cylinder head.

2. An engine valve seat comprising a plating layer formed on at least a surface of a valve seat main body, fitted into a concaved mounting reception portion provided at an air inlet or air outlet of a cylinder head, which faces said receiving portion, thus preventing galvanic corrosion originating from dissimilar metal contact with a valve seat at said concaved mounting reception portion of said cylinder head.

3. The engine valve seat according to claim 1, wherein a standard electrode potential of said plating layer is set between an electrode potential of said valve seat main body and an electrode potential of said mounting reception portion.

4. An engine cylinder head comprising a valve seat fitted into a concaved mounting reception portion provided at an air inlet or air outlet of the cylinder head, wherein a plating layer is formed on a surface of said concaved mounting reception portion and prevents galvanic corrosion originating from dissimilar metal contact with a valve seat at said concaved mounting reception portion of said cylinder head.

5. An engine cylinder head comprising:
a valve seat fitted into a concaved mounting reception portion provided at an air inlet or air outlet of the cylinder head, and
a plating layer formed on a surface of said concaved mounting reception portion which faces said valve seats and preventing galvanic corrosion originating from dissimilar metal contact with said valve seat at said concaved mounting reception portion of said cylinder head.

6. The engine cylinder head according to claim 4, wherein a standard electrode potential of said plating layer is set between an electrode potential of said valve seat and an electrode potential of said mounting reception portion.

7. An engine cylinder head comprising:
a valve seat fitted into a concaved mounting reception portion provided at an air inlet or air outlet of the cylinder head; and
plating layers are formed on both a surface of said concaved mounting reception portion and a surface of said valve seat preventing galvanic corrosion originating from dissimilar metal contact with said valve seat at said concaved mounting reception portion of said cylinder head.

8. An engine cylinder head comprising:
a valve seat fitted into a concaved mounting reception portion provided at an air inlet or air outlet of the cylinder head;
a plating layer formed on a surface of said concaved mounting reception portion which faces said valve seat; and
a plating layer is formed on a surface of said valve seat which faces said mounting reception portion, thus preventing galvanic corrosion originating from dissimilar metal contact with said valve seat at said concaved mounting reception portion of said cylinder head.

9. The engine cylinder head according to claim 7, wherein a material for said plating layer of said mounting reception portion and a material for said plating layer of said valve seat are provided in such a manner that electrode potentials equal or approximately equal to each other, or an electrode potential of said aluminum-based cylinder head, an electrode potential of said plating layer of said mounting reception portion, an electrode potential of said plating layer of said valve seat, and an electrode potential of said iron-based valve seat, increase in that order.

10. An engine valve seat comprising: an insulating layer formed on a surface of a valve seat main body fitted into a concaved mounting reception portion provided at an air inlet or air outlet of a cylinder head, wherein said valve seat main body is made of an iron-based alloy, and said insulating layer is an iron oxide film, preventing galvanic corrosion originating from dissimilar metal contact with said valve seat at said concaved mounting reception portion of said cylinder head.

11. An engine valve seat comprising an insulating layer formed on that surface of a valve seat main body, fitted into a concaved mounting reception portion provided at an air inlet or air outlet of a cylinder head, which faces said concaved mounting reception portion, wherein said valve seat main body is made of an iron-based alloy, and said insulating layer is an iron oxide film, thus preventing galvanic corrosion originating from dissimilar metal contact with said valve seat at said concaved mounting reception portion of said cylinder head.

12. A method of manufacturing a valve seat to be fitted into a concaved mounting reception portion provided at an air inlet or air outlet of a cylinder head, comprising the steps of:
forming an insulating layer on an entire surface of a valve seat main body;
fitting said valve seat main body into said concaved mounting reception portion;
removing said insulating layer on a seat surface of said valve seat main body; and
processing said seat surface,
wherein preventing galvanic corrosion originating from dissimilar metal contact with said valve seat at said concaved mounting reception portion of said cylinder head.

13. The valve seat manufacturing method according to claim 12, wherein said valve seat main body is made of an iron-based alloy, and further comprising the step of steaming the surface of said valve seat main body to form an iron oxide film as said insulating layer.

14. An engine valve seat comprising a coating layer for electrical insulation formed on a surface of a valve seat main body fitted into a concaved mounting reception portion provided at an air inlet or air outlet of a cylinder head preventing galvanic corrosion originating from dissimilar metal contact with said valve seat at said concaved mounting reception portion of said cylinder head.

15. An engine valve seat comprising a coating layer for electrical insulation formed on at least that surface of a valve seat main body, fitted into a concaved mounting reception portion provided at an air inlet or air outlet of a cylinder head, which faces said concaved mounting reception portion, preventing galvanic corrosion originating from dissimilar metal contact with said valve seat at said concaved mounting reception portion of said cylinder head.

16. An engine cylinder head having a valve seat fitted into a concaved mounting reception portion provided at an air inlet or air outlet of a cylinder head, wherein a coating layer for electrical insulation is formed on a surface of said mounting reception portion, preventing galvanic corrosion originating from dissimilar metal contact with said valve seat at said concaved mounting reception portion of said cylinder head.

17. The engine valve seat according to claim 14, wherein said coating layer is a ceramic coating layer.

18. The engine cylinder head according to claim 16, wherein said coating layer is a ceramic coating layer.

19. The engine valve seat according to claim 14, wherein said coating layer is a polytetrafluoroethylene resin layer.

20. The engine cylinder head according to claim 16, wherein said coating layer is a polytetrafluoroethylene resin layer.

21. The engine cylinder head according to claim 16, wherein said cylinder head is made of an aluminum alloy, and said coating layer is an alumite treated layer.

22. The engine valve seat according to claim 2, wherein a standard electrode potential of said plating layer is set between an electrode potential of said valve seat main body and an electrode potential of said mounting reception portion.

23. The engine cylinder head according to claim 5, wherein a standard electrode potential of said plating layer is set between an electrode potential of said valve seat and an electrode potential of said mounting reception portion.

24. The engine cylinder head according to claim 8, wherein a material for said plating layer of said mounting reception portion and a material for said plating layer of said valve seat are provided in such a manner that electrode potentials equal or approximately equal to each other, or an electrode potential of said aluminum-based cylinder head, an electrode potential of said plating layer of said mounting reception portion, an electrode potential of said plating layer of said valve seat, and an electrode potential of said iron-based valve seat, increase in that order.

25. The engine valve seat according to claim 15, wherein said coating layer is a ceramic coating layer.

26. The engine valve seat according to claim 15, wherein said coating layer is a polytetrafluoroethylene resin layer.
